(19) United States
(12) Patent Application Publication
(10) Pub. No.: US 2007/0297406 A1
(43) Pub. Date: Dec. 27, 2007

(54) Managing multicast groups

(76) Inventor: Mo Rooholamini, Chandler, AZ (US)

Correspondence Address: Grossman, Tucker, Perreault & Pfleger, PLLC;c/o Intellevate, P.O. Box 52050, Minneapolis, MN, 55402, US

(21) Appl. No.: 11/472,903

(22) Filed: Jun. 22, 2006

(51) Int. Cl. H04L 12/56; H04J 3/26

(52) U.S. Cl. 370/390; 370/432

(57) ABSTRACT

In a system supporting multicast operations between endpoints (e.g., between writer devices and listener devices) coupled to a switch fabric, multicast groups may be managed such that switches may be configured or reconfigured when endpoints are added to or removed from the multicast groups. Multicast groups may be managed by determining one or more multicast paths between at least one endpoint device and a plurality of endpoint devices in a multicast group, identifying at least one switch along the multicast path(s), and updating a path count for at least one port of the switch(es). The path count tracks a number of multicast paths going in to or out of the port (s) for the multicast group. Of course, many alternatives, variations, and modifications are possible without departing from this embodiment.

### FIELD

The present disclosure relates to switch fabrics, and more particularly, relates to multicast communications between endpoint devices coupled to an advanced switching interconnect (ASI) fabric.

### BACKGROUND

As computing and communications converge, the need for a common interconnect interface increases. The convergence trends of the compute and communications industries, along with inherent limitations of bus-based interconnect structures, has lead to the recent emergence of serial-based interconnect technologies. These new technologies range from proprietary interconnects for core network routers and switches to standardized serial technologies, applicable to computing, embedded applications and communications. One such standardized serial technology is the Peripheral Component Interconnect (PCI) Express™ architecture in accordance with the PCI Express™ Base Specification, Revision 1.0, published Jul. 22, 2002. In addition to providing a serial-based interconnect, the PCI Express™ architecture supports functionalities defined in the earlier Peripheral Component Interconnect (PCI) bus-based architectures.

A switch fabric architecture may allow different devices to be interconnected via a serial-based interconnect scheme. Advanced Switching Interconnect (ASI) defines one such switch fabric architecture based on the PCI Express™ architecture. ASI is capable of providing an interconnect solution for multi-host, peer-to-peer communications without additional bridges or media access control. ASI employs a packet-based transaction layer protocol that operates over the PCI Express™ physical and data link layers. In such manner, ASI provides enhanced features such as sophisticated packet routing, congestion management, multicast traffic support, as well ASI fabric redundancy and fail-over mechanisms to support high performance, highly utilized and high availability system environments.

During a multicast operation, at least one writer device may write to a plurality of listener devices within a multicast group and/or at least one listener device may listen to a plurality of writer devices. To support multicast operations, there is a need to manage the addition and removal of multicast group members such that switches are properly configured to route multicast packets from the correct writers to the correct listeners for each group.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 is a block diagram of a system including a switch fabric coupled to endpoint devices forming multicast groups, consistent with one embodiment of the present disclosure;

FIG. 2 is a block diagram of a system illustrating multicast communications between endpoint devices coupled to a switch fabric, consistent with one embodiment of the present disclosure;

FIG. 3 is a block diagram of one embodiment of a switch routing a multicast packet;

FIG. 4 is a diagram of a port path count table used to manage multicast groups, consistent with one embodiment of the present disclosure;

FIG. 5 is flow chart illustrating a method of managing multicast groups, consistent with one embodiment of the present disclosure;

FIG. 6 is flow chart illustrating a method of managing multicast groups when an endpoint device joins a multicast group, consistent with one embodiment of the present disclosure;

FIG. 7 is flow chart illustrating a method of managing multicast groups when an endpoint device is removed from a multicast group, consistent with one embodiment of the present disclosure; and

FIG. 8 is a block diagram of a communications implementation of one embodiment of the present disclosure.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRIPTION

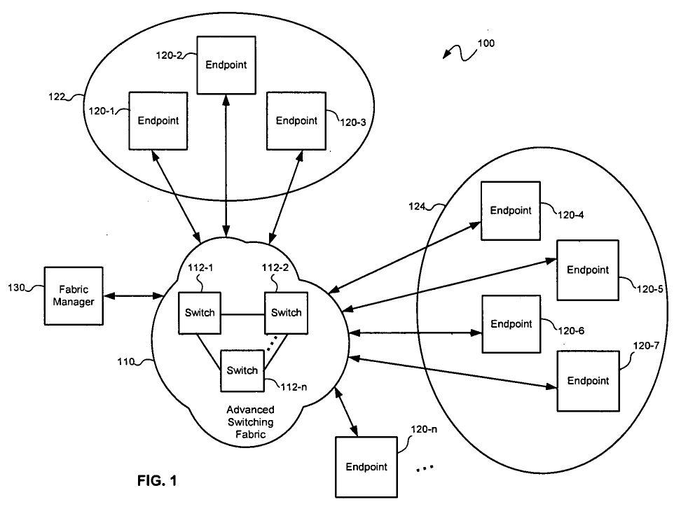

Referring to FIG. 1, consistent with the present disclosure, a system 100 may include a switch fabric 110 capable of providing peer-to-peer communications between endpoint devices 120-1 to 120-n. The switching fabric 110 may include a plurality of interconnected switches 112-1 to 112-n that route data packets between endpoint devices 120-1 to 120-n. In one exemplary embodiment, the switching fabric 110 is an Advanced Switching Interconnect (ASI) fabric architecture complying with or compatible with, at least in part, the Advanced Switching Interconnect (ASI) Core Architecture Specification Rev. 1.1, published November 2004, and/or later versions of the specification (the “ASI specification”). The switching fabric 110 may also include other fabric architectures that employ a packet-based transaction layer protocol. The endpoint devices 120-1 to 120-n may be any type of computing device and may include software to facilitate serial communications between the devices 120-1 to 120-n.

The system 100 may support multicast operations such that one or more writer endpoint devices may write to one or more listener endpoint devices and/or one or more listener endpoint devices may listen to one or more writer devices. In particular, the switches 112-1 to 112-n within the switching fabric 110 may replicate multicast data packets and may route the replicated packets based on multicast groups 122, 124 of endpoint devices 120-1 to 120-n. One of the endpoint devices in a multicast group 122 (i.e., the writer device), for example, may send multicast packets that are replicated and routed to the other endpoint devices in the multicast group 122 (i.e., the listener devices). As endpoint devices 120-1 to 120-n are added to and removed from multicast groups, switches 112-1 to 112-n may need to be configured or reconfigured to route the multicast packets from the correct writer endpoint devices to the correct listener devices, as will be described in greater detail below.

The system 100 may also include a fabric manager 130 to manage data transfer through the switching fabric 110. The fabric manager 130 may be responsible for various functions, such as device discovery, device configuration, fabric discovery, and management of multicast groups. The fabric manager 130 may be any type of platform (e.g., a computing device) operating fabric management software.

In one exemplary embodiment, the fabric manager 130 may include fabric management software complying with or compatible with, at least in part, the Fabric Management Framework (FMF) Specification, Revision 0.7, published May 2006, and/or later versions of the specification (the “FMF specification”). In this embodiment, the fabric manager 130 may be implemented as one or more endpoints configured as a fabric owner. Fabric management software may be implemented as a single component or as a set of collaborative components, for example, running on one or more endpoint devices.

The switching fabric 1 10 may include different numbers of switching devices 112-1 to 112-n, and different numbers of endpoint devices 120-1 to 120-n may be coupled to the switching fabric 110 forming different numbers of multicast groups 122, 124. Although each of the endpoint devices 120-1 to 120-7 in the exemplary embodiment are members of only one of the multicast groups 122, 124, an endpoint device may be a member of more than one multicast group. Also, one or more endpoint devices (e.g., endpoint device 120-n) in the system 100 may not be a member of any multicast group. Any one of the endpoint devices 120-1 to 120-n may also be capable of unicast peer-to-peer communications with any one of the other endpoint devices 120-1 to 120-n coupled to the switching fabric 110.

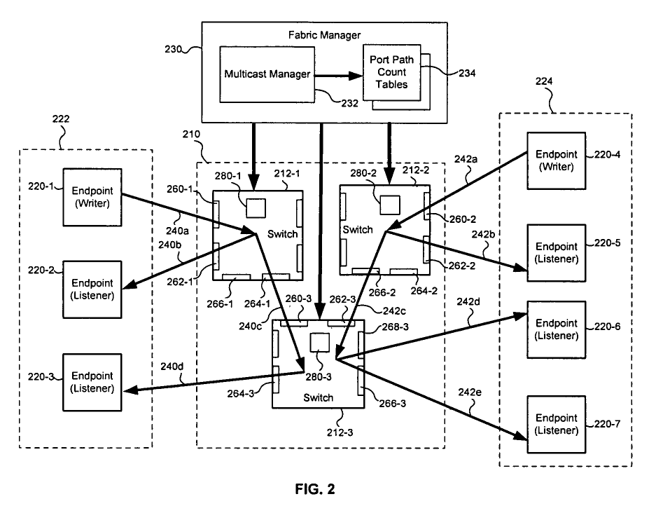

Referring to FIG. 2, examples of multicast communications between endpoint devices in multicast groups are illustrated and described in greater detail. In this embodiment, a switching fabric 210 interconnects endpoint devices 220-1 to 220-3 forming a multicast group 222 and endpoint devices 220-4 to 220-7 forming a multicast group 224. When a writer device within one of the multicast groups 222, 224 sends a multicast packet, the multicast packet will be routed by the switches 212-1 to 212-3 in the switching fabric 210 to the other endpoint devices (i.e., the listener devices) within the respective multicast group. The paths taken by multicast data packets as the packets are routed from a writer device to listener devices within a multicast group are referred to as multicast paths.

In the multicast group 222, for example, the endpoint device 220-1 is shown as a writer device and the endpoint devices 220-2 and 220-3 are shown as listener devices. In this example, multicast packets sent by the writer endpoint device 220-1 follow multicast paths 240a-240d through switches 212-1 and 212-3 to the listener endpoint devices 220-2 and 220-3 within the multicast group 222. In the multicast group 224, the endpoint device 220-4 is shown as a writer device and the endpoint devices 220-5 to 220-7 are shown as listener devices. In this example, multicast packets sent by the writer endpoint device 220-4 follow multicast paths 242a-242e through switches 212-2 and 212-3 to the listener endpoint devices 220-5 to 220-7 within the multicast group 224. Any one of the endpoint devices 220-1 to 220-7 may be a member of the multicast groups 222, 224, respectively, as a writer device, a listener device or both.

The switches 212-1 to 212-3 may include ports that couple the switch to other devices (e.g., other switches or endpoint devices). The ports may include ingress ports, such as port 260-1 in switch 212-1, port 260-2 in switch 212-2, and ports 260-3, 262-3 in switch 212-3, which allow data from other devices to pass into a switch. The ports may also include egress ports, such as ports 262-1, 264-1 in switch 212-1, ports 262-2, 266-2 in switch 212-2, and ports 264-3, 266-3, 268-3 in switch 212-3, which allow data to pass out of the switch to other devices. In other words, ingress ports may allow multicast paths (e.g., paths 240a, 242a) to go into a switch and egress ports may allow multicast paths (e.g., paths 240b, 240d, 242b, 242d, 242e) to go out of a switch.

Ports may be used by more than one multicast communication such that more than one multicast path for a multicast group may pass through one or more of the ports. If the endpoint device 220-7 were also a member of the multicast group 224 as a writer device, for example, the egress port 262-2 may be used both when the endpoint device 220-4 sends a multicast packet (as shown) and when the endpoint device 220-7 sends a multicast packet. As such, the egress port 262-2 may be used by two multicast paths associated with the multicast group 224 and may have a path count of two.

To route the multicast data packets, the switches 212-1 to 212-3 may include multicast tables 280-1 to 280-3, such as look up tables, indicating which ports are enabled and disabled for the existing multicast groups. For the multicast group 222 shown in FIG. 2, for example, the multicast table 280-1 in switch 212-1 may indicate that ingress port 260-1 and egress ports 264-1, 262-1 are enabled and the multicast table 280-3 in the switch 212-3 may indicate that ingress port 260-3 and egress port 264-3 are enabled.

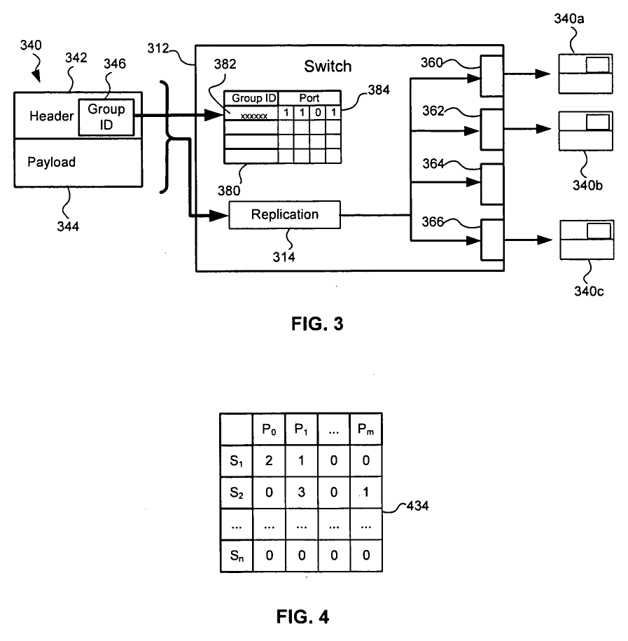

FIG. 3 illustrates one example of the routing of a multicast packet 340 through a switch 312 in a switching fabric supporting multicast operations. The multicast packet 340 may be forwarded to the switch 312, for example, from a writer endpoint device or from another switch. The multicast packet 340 may include a header 342 and payload 344. The header 342 of the multicast packet 340 may include a group identifier 346 identifying a multicast group associated with the packet 340. For example, a writer endpoint device initiating the multicast communication within a multicast group may specify the multicast group by inserting the group identifier 346 in the header 342 of the multicast packet 340.

The switch 312 may include a multicast table 380 identifying ports that are enabled or disabled for the group identifiers associated with groups that have been created. For example, the multicast table 380 may include a multicast group identifier 382 for each of the multicast groups for which the switch is configured and registers 384 including port bit fields for each of the ports 360, 362, 364, 366 of the switch. The registers 384 indicate the status of the ports 360, 362, 364, 366 (i.e., enabled/disabled) for the corresponding multicast group identifiers. If a port is enabled for a particular multicast group, for example, the port bit field for that port and group identifier is set. If a port is disabled for a particular multicast group, the port bit field for that port and group identifier is cleared.

The switch 312 receiving the packet 340 may determine which of the ports 360, 362, 364, 366 are enabled for routing the packet 340 based on the group identifier 346 in the packet 340. For example, the switch 312 may look up the group identifier 346 from the packet 340 in the multicast table 380 to determine which registers 384 indicate that ports are enabled for that group identifier. As shown in the illustrated example, the three egress ports 360, 362, 366 are enabled for the group identifier 346 included in the multicast packet 340. When the switch 312 receives a multicast packet 340, the switch 312 may replicate the packet 340 for the number of egress ports enabled for that multicast group, for example, as indicated by the table 380. To replicate the packet 340, the switch 312 may include replication logic 314 implemented as software, hardware, firmware, or any combination thereof, as is generally known to those skilled in the art. The switch 312 may then forward the replicated packets 340a-340c out the enabled egress ports 360, 362, 366.

Referring back to FIG. 2, a fabric manager 230 may manage the creation of multicast groups, the addition and removal of endpoint devices as writer devices and/or listener devices, and the configuration of the switches. The fabric manager 230 may also maintain information about the multicast groups, such as group identifiers, group members, the roles (e.g., writer or listener) of group members, and the established multicast paths between the writers and listeners. The fabric manager 230 may include a multicast manager 232 to track the number of paths going through the ports in the switches 212-1 to 212-3 to determine if any of the ports in the switches 212-1 to 212-3 should be configured or reconfigured when endpoint devices are added to or removed from multicast groups 222, 224.

The multicast manager 232 may track path counts by maintaining port path count tables 234 associated with the multicast groups that have been created by the fabric manager 230. For each of the multicast groups, port path count tables 234 track the number of paths through the ports of the switches configured to route multicast packets sent by members of the respective multicast groups. In one embodiment, two port path count tables 234 are maintained for each of the multicast groups—an ingress port path count table to track the number of paths through ingress ports of the switches and an egress port path count table to track the number of paths through egress ports of the switches. By tracking the number of paths that go through the ingress and egress ports in the switches 212-1 to 212-3 using the port path count tables 234, the fabric manager 230 may determine if and when the switch multicast tables 280-1 to 280-3 need to be configured or reconfigured when there is a change in multicast group membership.

One embodiment of a port path count table 434 for a particular multicast group is shown in greater detail in FIG. 4. As shown for this particular multicast group, for example, two multicast paths go through the port P₀ of the switch S₁, one multicast path goes through port P₁ of the switch S₁, three multicast paths go through port P₁ of the switch S₂, one multicast path goes through port Pₘ of the switch S₂, and no multicast paths go through the other ports of the other switches.

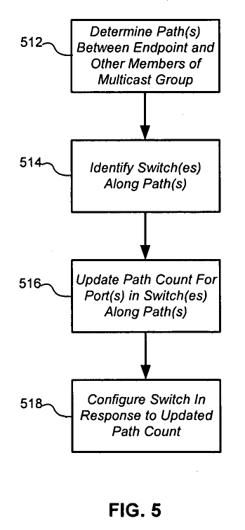

FIG. 5 illustrates one general method for managing multicast groups. When an endpoint device is to be added to or removed from a multicast group, one or more multicast paths between the endpoint device to be added or removed and the other members of the multicast group may be determined 512 and one or more switches along the multicast path(s) may be identified 514. For example, the fabric manager 230 may determine the multicast path(s) and identify the switches from existing multicast path information that identifies and describes multicast paths between endpoint devices. Such existing multicast path information may be stored (e.g., in the computing device acting as the fabric manager 230) in a cache memory, dynamic random access memory (DRAM), or other such storage device. In one embodiment, multicast path information may be a dynamic data structure implemented as a linked list.

The existing multicast path information may correspond to the most direct or efficient routes between an endpoint and each of the other endpoints within a multicast group as determined by, for example, the fabric manager 230 during device discovery, device configuration and/or topology discovery. A topology discovery process, such as the topology service defined by the FMF Specification, may be executed by the fabric manager 230 before other processes to determine the fabric topology, fabric connectivity information, devices comprising the fabric, and device attributes. During fabric run-time, the fabric topology may be used to compute paths (e.g., shortest or least congested) between pairs of endpoints that need to communicate with each other, for example, for peer-to-peer communications. If no existing multicast path information exists for an endpoint device (e.g., when first added to a group), the fabric manager 230 may determine one or more multicast path(s) for that endpoint device by retrieving previously computed path information for paths between pairs of endpoints, i.e., between the endpoint device to be joined and each of the endpoints in the multicast group. Alternatively, the fabric manager 230 may compute the paths between the endpoint device to be joined and each of the endpoints in the multicast group when the endpoint requests to be joined. The fabric manager 230 may also update existing multicast path information, for example, as the topology changes and/or as more direct or efficient routes are discovered.

For each of the identified switches in each of the multicast paths, a path count may be updated 516 for one or more ports in the switches as a result of the addition or removal of the endpoint device requesting to be added to or removed from a multicast group. The path count represents a current number of multicast paths that may go through a port for a particular multicast group. In response to the updated path count, the switch(es) along the multicast path(s) for the affected multicast group may be configured (or reconfigured) 518 as necessary. For example, if the updated path count indicates that a port previously had zero paths going through the port and now has at least one path as a result of a new group member, the previously disabled port may be enabled. Similarly, if the updated path count indicates that a port previously had at least one path going through the port and now has zero paths as a result of a removed group member, the previously enabled port may be disabled. Using this method of managing multicast groups may reduce the number of times that the fabric manager must access the multicast table registers to configure or reconfigure the switches, thereby minimizing packet generation and fabric traffic.

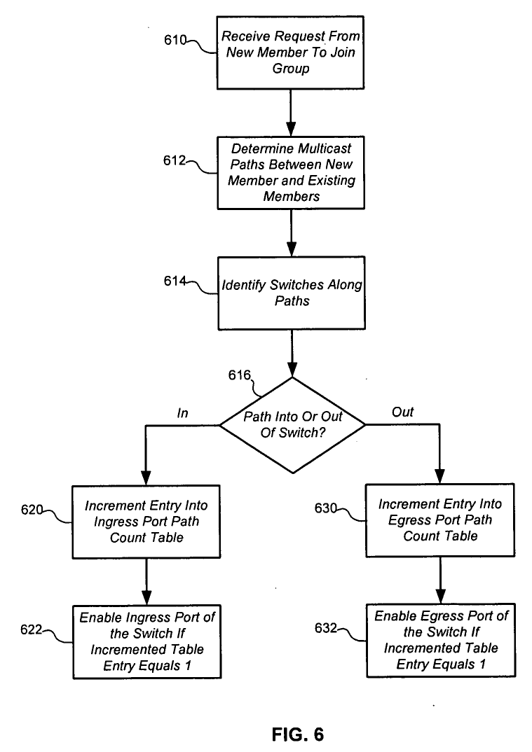

FIG. 6 shows one method of managing a multicast group when a new member is added to the group. The fabric manager may receive 610 a request from a new member to join a multicast group. The request may be in the form of a request packet from an endpoint device identifying, for example, the multicast group, the endpoint device, and role of the endpoint device (e.g., writer and/or listener). After receiving the join request packet, the fabric manager may also perform some error checking, for example, by verifying that the member requesting to join the multicast group is not already a member of the group. The fabric manager may then determine 612 multicast paths between the new member and the existing members of the group and may identify 614 the switches along the multicast paths. For example, the fabric manager may retrieve existing multicast path information defining the multicast paths between the new member and the existing members of the group.

If the fabric manager determines 616 that a path goes into a switch, the fabric manager increments 620 an entry for the corresponding switch and ingress port in the ingress port path count table associated with that multicast group. If the updated table entry in the ingress port path count table equals 1, the fabric manager enables 622 the corresponding ingress port of the switch. If the fabric manager determines 616 that a path goes out of a switch, the fabric manager increments an entry for the corresponding switch and egress port in the egress port path count table associated with that multicast group. If the updated table entry in the egress port path count table equals 1, the fabric manager enables 632 the corresponding egress port of the switch. The fabric manager may enable ingress and egress ports, for example, by sending a packet to the switch instructing the switch to set the corresponding bit field in the multicast table register of the switch. The port path count tables may be incremented 620, 630 and ports may be enabled 622, 632 (if necessary) for each of the identified switches along the multicast paths between the new member and the existing members of the multicast group. After the appropriate switch ports have been enabled, the fabric manager may send a response packet to notify the requesting new member or endpoint that the multicast paths have been established.

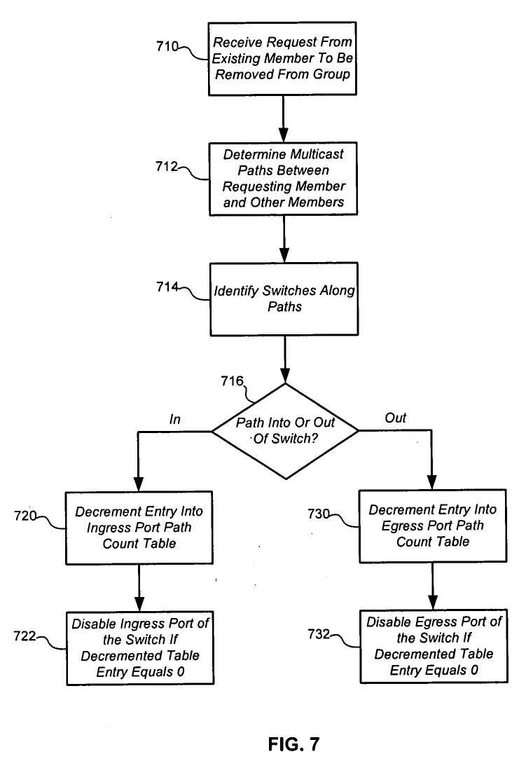

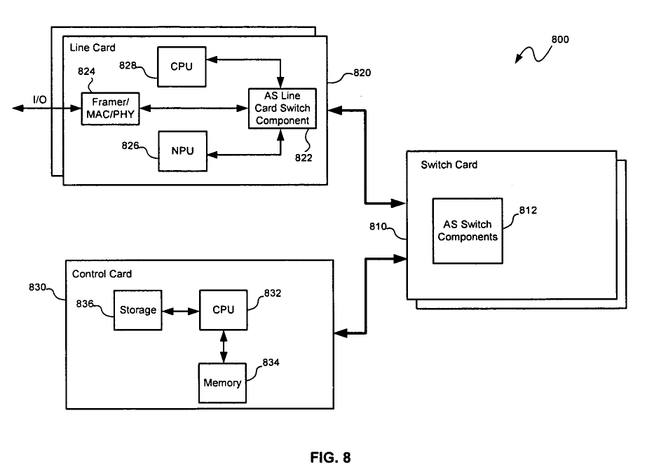

FIG. 7 shows one method of managing a multicast group when a new member is removed from the group. A fabric manager may receive 710 a request from an existing member to be removed from a multicast group. The request may be in the form of a request packet from an endpoint device identifying, for example, the multicast group and the endpoint device. After receiving the remove request packet, the fabric manager may also perform some error checking, for example, by verifying that the member requesting removal from the multicast group is already a member of the group. The fabric manager may then determine 712 multicast paths between the member requesting removal and the other members of the group and may identify 714 switches along the multicast paths. For example, the fabric manager may retrieve the existing multicast path information that was stored in memory when the member requesting removal joined the multicast group.

If the fabric manager determines 716 that a path goes into a switch, the fabric manager decrements 720 an entry for the corresponding switch and ingress port in the ingress port path count table associated with that multicast group. If the updated table entry in the ingress port path count table equals 0, the fabric manager disables 722 the corresponding ingress port of the switch. If a path goes out of a switch, the fabric manager decrements 730 an entry for the corresponding switch and egress port in the egress port path count table associated with that multicast group. If the updated table entry in the egress port path count table equals 0, the fabric manager disables 732 the corresponding egress port of the switch. The fabric manager may disable ingress and egress ports, for example, by sending a packet to the switch instructing the switch to clear the corresponding bit field in the multicast table register of the switch. The port path count tables may be decremented 720, 730 and ports may be disabled 722, 732 (if necessary) for each of the identified switches along the multicast paths between the member to be removed and the other members of the multicast group. After the appropriate switch ports have been disabled, the fabric manager may send a response packet to notify the requesting member or endpoint that the multicast paths have been removed.

Referring again to FIG. 2, for example, the endpoint device 220-4 may send a request to the fabric manager 230 to be removed from the multicast group 224. After receiving the request, the fabric manager 230 may determine that the paths 242a-242e exist between the endpoint device 220-4 and the other endpoint devices 220-5 to 220-7 in the multicast group 224 and may identify the switches 212-2 and 212-3 along those paths 242a-242e. The multicast manager 232 may then decrement the path count for the ingress ports 260-2 and 262-3 and the egress ports 262-2, 266-2, 266-3, and 268-3 in those switches 212-2 and 212-3. If the path count for any one of the ports 260-2, 262-3, 262-2, 266-2, 266-3, and 268-3 goes to zero, the fabric manager 230 may disable that port by sending a packet to the respective switch 212-2, 212-3 instructing the switch to clear the bit field in the multicast table for the port to be disabled.

Although the methods of managing multicast groups described above refer to a single endpoint being added to or removed from a multicast group, these methods may also be used when an entire multicast group is created or eliminated. When a multicast group is created or eliminated, the methods described above may be repeated for each of the endpoints in the multicast group.

Embodiments of the methods for managing multicast groups described above may be implemented in a computer program that may be stored on a storage medium having instructions to program a system to perform the methods. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions. Other embodiments may be implemented as software modules executed by a programmable control device.

Referring to FIG. 8, the systems and methods of managing multicast groups, consistent with embodiments of the present invention described above, may be implemented in a communications system 800. The communications system 800 may include one or more switch cards 810, one or more line cards 820, and one or more control cards 830. The switch card(s) 810 may be representative of an ASI fabric, such as ASI fabric 110 shown in FIG. 1 or ASI fabric 210 shown in FIG. 2, and may be used to support the ASI switch fabric functionality. The switch card(s) 810 may include ASI switch components 812 that control switching of communications between various endpoints of the communication system 800. The switch card(s) 810 may also include other components (not shown), such as a central processing unit (CPU), a memory, and a storage medium, (e.g., a nonvolatile memory device) that stores one or more software components, for example, to handle replication of multicast packets and switching of data communications.

The line card(s) 820 may be coupled to switch card 810 via a serial interconnect. The line card(s) 820 may correspond to one or more endpoints of the system 800, for example, as a writer device and/or a listener device. The line card(s) 820 may include a local ASI switch component 822 that is linked to local framer/media access control (MAC)/physical layer (PHY) component(s) 824, NPU(s) 826, and/or CPU(s) 828. The framer/MAC/PHY component(s) 824 may be used to connect the line card(s) 820 to other locations via an I/O data link and may also be coupled directly to ASI line card switch component 822, for example, via an ASI link. The line card(s) 820 may also include memory and/or storage components (not shown) coupled to the CPU 828.

The control card(s) 830 may include a CPU 832 coupled between a memory 834 and a storage 836. In one embodiment, the storage 836 may be a nonvolatile memory to store one or more software components used to handle fabric management functions such as the multicast group management described above.

The switch card(s) 810, line card(s) 820 and control card(s) 830 may be implemented in modular systems that employ serial-based interconnect fabrics, such as PCI Express™ components. One example of such modular communication systems includes Advanced Telecommunications Computing Architecture (AdvancedTCA) systems.

Although shown with the particular components in FIG. 8 for exemplary purposes, it is to be understood that a communication system providing multicast group management may include other devices in various other embodiments. In some embodiments, the functionalities of one or more endpoint devices, the fabric manager, and the ASI fabric may be implemented within a single platform or portion thereof. The scope of the present disclosure should not be construed as being limited to any particular computer system or form factor.

Other implementations of the system and method for managing multicast groups may include a storage platform or a bladed server system. One embodiment of a storage platform implementation may include a switch fabric interconnecting storage processor blades and storage area network blades. One embodiment of a bladed server system may include a switch fabric interconnecting server blades.

Accordingly, a method, consistent with one embodiment, may include: determining at least one multicast path between at least one endpoint device and a plurality of endpoint devices in a multicast group; identifying at least one switch along the at least one multicast path; and updating a path count for at least one port of the at least one switch. The path count tracks a number of multicast paths going in to or out of the at least one port for the multicast group.

Consistent with another embodiment, an article may include a machine-readable storage medium containing instructions that if executed enable a system to determine at least one path between at least one endpoint device and a plurality of endpoint devices in a multicast group, to identify at least one switch along the at least one path; and to update a path count for at least one port of the at least one switch.

Consistent with a further embodiment, a system may include a plurality of line cards, a switch fabric interconnecting the line cards, and at least one control card coupled to the switch fabric. The control card may include a processor and a storage coupled to the processor storing instructions that if executed enable the processor to determine at least one path between at least one endpoint device and a plurality of endpoint devices in a multicast group, to identify at least one switch along the at least one path, and to update a path count for at least one port of the at least one switch.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. A method comprising:
determining at least one multicast path between at least one endpoint device and a plurality of endpoint devices in a multicast group;
identifying at least one switch along said at least one multicast path; and
updating a path count for at least one port of said at least one switch, wherein said path count is updated and stored by a fabric manager coupled to said at least one switch, wherein said path count tracks a number of multicast paths going in to or out of said at least one port for said multicast group.

2. The system of claim 1 wherein said at least one path is determined in response to receiving a request from at least one new endpoint device to join said multicast group.

3. The system of claim 1 wherein said at least one path is determined in response to receiving a request from at least one endpoint device to be removed from said multicast group.

4. The system of claim 1 further comprising configuring said switch in response to said updated path count.

5. The system of claim 4 wherein configuring said switch includes enabling said at least one port of said switch if said updated path count equals one.

6. The system of claim 4 wherein configuring said switch includes disabling said at least one port of said switch if said updated path count equals zero.

7. The system of claim 1 wherein identifying said at least one switch comprises identifying a plurality of switches in a switch fabric, wherein said switch fabric employs a packet-based transaction layer protocol.

8. The system of claim 1 wherein identifying said at least one switch comprises identifying a plurality of switches in a switch fabric, and wherein updating said path count comprises updating said path count for a plurality of ports in each of said plurality of switches.

9. The system of claim 1 wherein updating said path count comprises updating a port path count table associated with said multicast group.

10. The system of claim 9 wherein updating said port path count table comprises updating an ingress port path count table if said at least one path goes into said switch or updating an egress port path count table if said at least one path goes out of said switch.

11. An article comprising a machine-readable storage medium containing instructions that if executed enable a system to:
determine at least one path between at least one endpoint device and a plurality of endpoint devices in a multicast group;
identify at least one switch along said at least one path; and
update a path count for at least one port of said at least one switch, wherein said path count tracks a number of multicast paths going in to or out of said at least one port for said multicast group.

12. The article of claim 11 wherein said at least one path is determined in response to receiving a request from at least one new endpoint device to join said multicast group or in response to a request from at least one endpoint device to be removed from said multicast group.

13. The article of claim 11 further comprising instructions that if executed enable the system to configure said switch in response to said updated path count.

14. The article of claim 11 further comprising instructions that if executed enable the system to enable said at least one port of said switch if said updated path count equals one and to disable said at least one port of said switch if said updated path count equals zero.

15. An apparatus comprising:
a processor; and
a storage coupled to said processor storing instructions that if executed enable the processor to determine at least one path between at least one endpoint device and a plurality of endpoint devices in a multicast group, to identify at least one switch along said at least one path, and to update a path count for at least one port of said at least one switch, wherein said path count tracks a number of multicast paths going in to or out of said at least one port for said multicast group.

16. The apparatus of claim 15 wherein said at least one path is determined in response to receiving a request from at least one new endpoint device to join said multicast group or in response to a request from at least one endpoint device to be removed from said multicast group.

17. The apparatus of claim 15 wherein said storage stores instructions that if executed enable the processor to configure said switch in response to said updated path count.

18. The apparatus of claim 15 wherein said storage stores at least one port path count table associated with said multicast group.

19. The apparatus of claim 15 wherein said apparatus is a control card.

20. A system comprising:
a plurality of line cards;
a switch fabric interconnecting said line cards; and
at least one control card coupled to said switching fabric, said control card comprising:
a processor; and
a storage coupled to said processor storing instructions that if executed enable the processor to determine at least one path between at least one endpoint device and a plurality of endpoint devices in a multicast group, to identify at least one switch along said at least one path, and to update a path count for at least one port of said at least one switch, wherein said path count tracks a number of multicast paths going in to or out of said at least one port for said multicast group.

21. The system of claim 20 wherein said switch fabric is an Advanced Switching Interconnect (ASI) fabric.

22. The system of claim 20 wherein said switch fabric employs a packet-based transaction layer protocol.

23. The system of claim 21 wherein said storage in said control card stores instructions that if executed enable the processor to perform Fabric Management Protocol (FMF) functions.

24. The system of claim 20 wherein said at least one path is determined in response to receiving a request from at least one new endpoint device to join said multicast group or in response to receiving a request from at least one endpoint device to be removed from said multicast group.

25. The system of claim 20 wherein said storage in said control card stores instructions that if executed enable the processor to configure said switch in said switch fabric in response to said updated path count.

26. The system of claim 20 wherein said switch fabric includes a plurality of switch cards in an Advanced Telecommunications Computing Architecture (AdvancedTCA) system.
